(19) United States
(12) Patent Application Publication
(10) Pub. No.: US 2021/0284000 A1
(43) Pub. Date: Sep. 16, 2021

(54) VEHICLE ROOF PANEL AND VEHICLE ROOF STRUCTURE

(71) Applicant: KABUSHIKI KAISHA TOYOTA JIDOSHOKKI, Kariya-shi, Aichi-ken (JP)

(72) Inventors: Yuichi MIZUTANI, Kariya-shi (JP); Hirotaka INABA, Kariya-shi (JP); Kazumasa OKUMURA, Kariya-shi (JP)

(73) Assignee: KABUSHIKI KAISHA TOYOTA JIDOSHOKKI, Kariya-shi, Aichi-ken (JP)

(21) Appl. No.: 16/319,578

(22) PCT Filed: Jul. 10, 2017
(86) PCT No.: PCT/JP2017/025104

§ 371 Date: Jan. 22, 2019

(30) Foreign Application Priority Data
Jul. 25, 2016 (JP) 2016-145042

(51) Int. Cl. B60J 7/043

(52) U.S. Cl. CPC B60J 7/043

(57) ABSTRACT

This vehicle roof panel is formed from a plastic and is configured such that: the vehicle roof panel is disposed between a transparent, plate-shaped roof window and an operating mechanism for operating the roof window; and the vehicle roof panel is affixed to a vehicle body. The vehicle roof panel has a panel body and a front surface layer. The panel body comprises an opaque plastic, has an accommodation section configured to accommodate the roof window, and can shield the operating mechanism. The front surface layer comprises a transparent plastic, is formed integrally with the front surface of the panel body, and is substantially flush with a first surface.

### TECHNICAL FIELD

The present invention relates to a vehicle roof panel and a vehicle roof structure.

### BACKGROUND ART

Patent document 1 discloses a conventional vehicle roof structure. The roof structure includes a roof window, an actuation mechanism, and a vehicle roof panel. The roof window is a transparent plate and includes a first surface located at an outer side of the vehicle and a second surface located at the opposite side of the first surface, that is, at an inner side of the vehicle. The actuation mechanism is arranged at an inner side of the vehicle body at a location opposing the second surface of the roof window. The actuation mechanism includes multiple driving motors and is configured to move the roof window in a front-rear direction of the vehicle. The vehicle roof panel is fixed to the vehicle body in a state sandwiched between the roof window and the actuation mechanism. The vehicle roof panel is formed from transparent inorganic glass. The vehicle roof panel includes an accommodation portion that accommodates the roof window. The vehicle roof panel and the roof window are both tinted.

With the roof structure, the vehicle roof panel forms the roof of the vehicle body. Further, the vehicle roof panel covers the actuation mechanism and protects the actuation mechanism from water and dust.

### PRIOR ART LITERATURE

### Patent Literature

Patent Document 1: Japanese Laid-Open Patent Publication No. 2009-35018

### SUMMARY OF THE INVENTION

### Problem to be Solved by the Invention

In order to reduce the weight of the vehicle and facilitate manufacturing, a roof structure having a plastic vehicle roof panel has been developed. In this case, there is a need for the vehicle roof panel to conceal the actuation mechanism so that the actuation mechanism is not exposed from the roof and so that the actuation mechanism does not adversely affect the aesthetic appeal. In this regard, the plastic vehicle roof panel is colored in an opaque color such as black.

However, in this case, the appearance of the colored vehicle roof panel will greatly differ from that of the transparent roof window. With such a roof structure, the roof window and the vehicle roof panel do not appear to have uniformity and it will be difficult to increase the aesthetic appeal. In this regard, the vehicle roof panel can be elaborately colored so that its appearance becomes close to that of the roof window. However, this will complicate the manufacturing process and increase the manufacturing cost.

The object of the present invention is to provide a vehicle roof panel and a vehicle roof structure that have high aesthetic appeal and reduce the manufacturing cost.

### Means for Solving the Problem

The present invention according to one mode provides a vehicle roof panel that is formed from a plastic and configured to be fixed to a vehicle body. The vehicle roof panel is configured to be arranged between a roof window that is a transparent plate and an actuation mechanism that actuates the roof window. The roof window includes a first surface and a second surface located on an opposite side of the first surface. The actuation mechanism is arranged to oppose the second surface of the roof window. The vehicle roof panel includes a main panel body and a surface layer. The main panel body is formed from an opaque plastic and includes an accommodation portion configured to accommodate the roof window. The main panel body is configured to conceal the actuation mechanism. The surface layer is formed from a transparent plastic, integrated with an outer surface of the main panel body, and substantially flush with the first surface.

The present invention according to another mode provides a roof window that includes a roof window, an actuation mechanism, and a vehicle roof panel. The roof window is a transparent plate and includes a first surface and a second surface located on an opposite side of the first surface. The actuation mechanism is arranged to oppose the second surface of the roof window and configured to actuate the roof window. The vehicle roof panel is formed from a plastic and arranged between the roof window and the actuation mechanism. The vehicle roof panel is configured to be fixed to a vehicle body. The vehicle roof panel includes a main panel body and a surface layer. The main panel body is formed from an opaque plastic and includes an accommodation portion configured to accommodate the roof window. The main panel body is configured to conceal the actuation mechanism. The surface layer is formed from a transparent plastic, integrated with an outer surface of the main panel body, and is substantially flush with the first surface.

### BRIEF DESCRIPTION OF THE DRAWINGS

FIG. 1 is an exploded perspective view of a vehicle roof structure according to a first embodiment.

FIG. 2 is an enlarged cross-sectional view of the vehicle roof structure according to the first embodiment taken along A-A in FIG. 1.

FIG. 3 is an enlarged cross-sectional view of a vehicle roof panel in the vehicle roof structure according to the first embodiment.

FIG. 4 is an enlarged cross-sectional view of the vehicle roof structure according to the first embodiment taken along B-B in FIG. 1.

FIG. 5 is an enlarged cross-sectional view of a vehicle roof panel in a vehicle roof structure according to a second embodiment.

FIG. 6 is an enlarged cross-sectional view of a vehicle roof panel in a vehicle roof structure according to a third embodiment.

FIG. 7 is a perspective view of a vehicle roof panel in a vehicle roof structure according to a fourth embodiment.

### EMBODIMENTS OF THE INVENTION

First to fourth embodiments according to the present invention will now be described with reference to drawings.

### First Embodiment

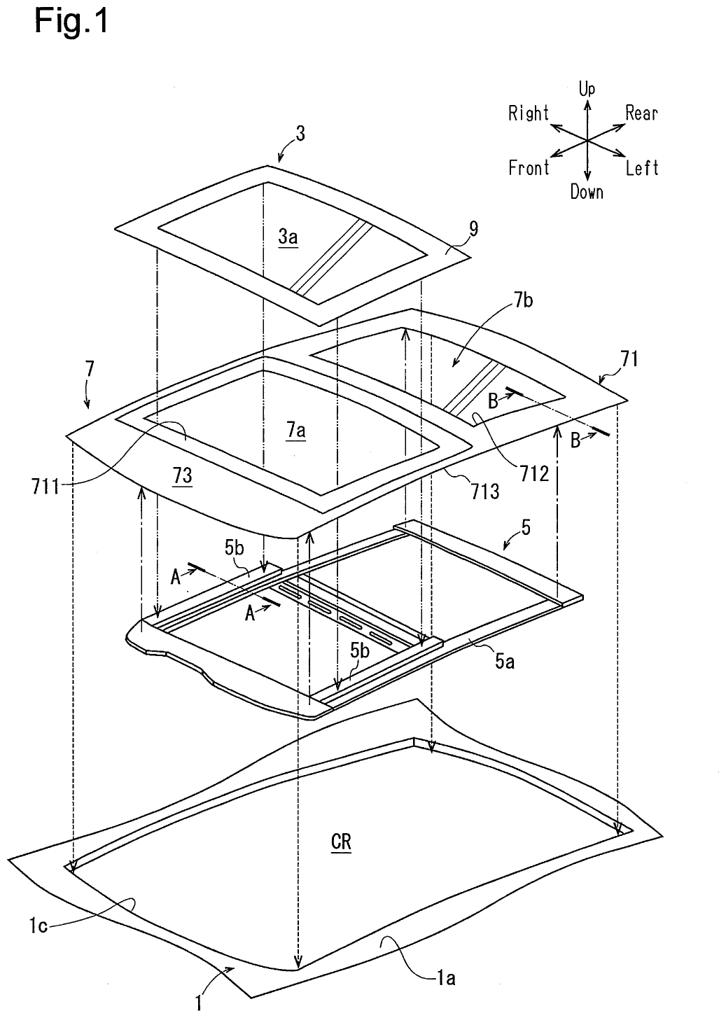

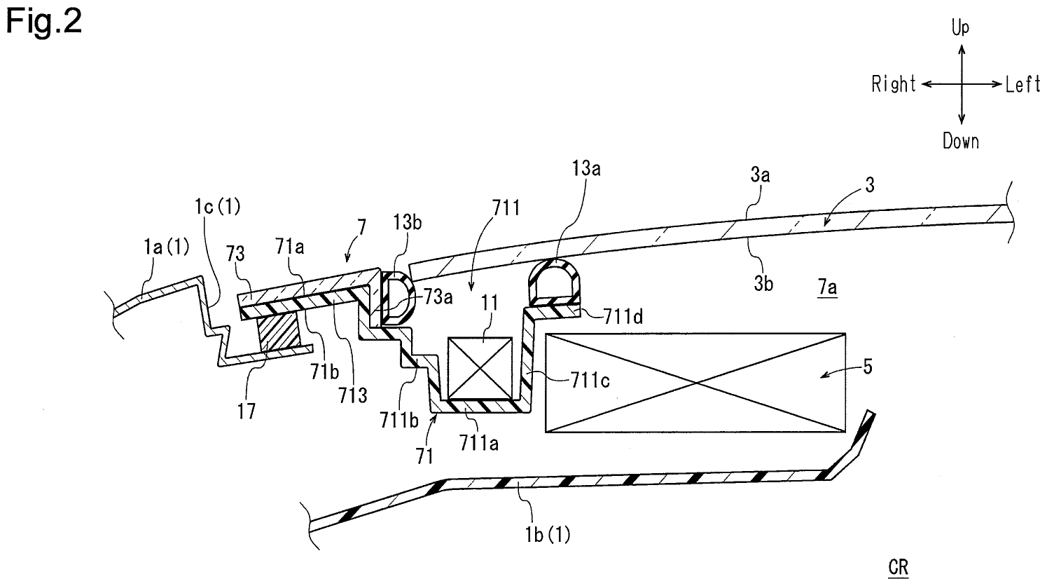

As shown in FIG. 1, a roof structure according to the first embodiment is employed in a vehicle body 1 to form a vehicle roof. The roof structure includes a roof window 3, an actuation mechanism 5, and a vehicle roof panel 7. In FIG. 1, the arrowed solid lines indicate frontward and rearward directions, leftward and rightward directions, and upward and downward directions of the vehicle. In FIGS. 2 to 7, the leftward and rightward directions correspond to FIG. 1.

As shown in FIG. 2, the body 1 includes a metal body panel 1a and a plastic interior panel 1b. The body panel 1a determines the outer shape of the vehicle, and the interior panel 1b defines a passenger compartment CR. The body panel 1a includes an opening 1c that is in communication with the passenger compartment CR. As shown in FIG. 1, the opening 1c is rectangular and has a greater length in the frontward and rearward directions than in the leftward and rightward directions. The opening 1c may be designed to have any shape. FIG. 1 does not show the interior panel 1b.

As shown in FIGS. 1 and 2, the roof window 3 is a plate and includes a first surface 3a and a second surface 3b that is located at an opposite side of the first surface 3a. The roof window 3 is shaped to be substantially rectangular having a front-rear length that is longer than a sideward length. The first surface 3a is exposed to the outside of the vehicle, and the second surface 3b is exposed to the passenger compartment CR.

The roof window 3 is formed from colorless transparent inorganic glass having a uniform thickness. Accordingly, the roof window 3 has light-transmissivity from the first surface 3a to the second surface 3b. Further, as shown in FIG. 1, the roof window 3 includes a frame-shaped concealing portion 9. The concealing portion 9 is formed by painting or printing the periphery of the second surface 3b with black color, which is an opaque color. FIG. 2 does not show the concealing portion 9 to facilitate illustration. The concealing portion 9 may be formed by any means of painting or printing an opaque color other than black. Further, the roof window 3 does not have to be colorless and transparent and may be colored and transparent through any process including tinting.

As shown in FIG. 1, the actuation mechanism 5 includes rails 5a and two open-close devices 5b. The rails 5a form a substantially rectangular frame by combining multiple steel materials. The rails 5a have a greater length in the frontward and rearward directions than in the leftward and rightward directions. A sunshade (not shown) is coupled to the rail 5a. The open-close devices 5b are coupled to the rail 5a. The open-close devices 5b include components (not shown) such as a drive motor and a gear. The structure of the actuation mechanism 5 including the open-close devices 5b is the same as a known actuation mechanism and thereby will not be described in detail. FIG. 2 schematically shows the actuation mechanism 5.

The vehicle roof panel 7 is substantially rectangular. The vehicle roof panel 7 has a greater length in the frontward and rearward directions than in the leftward and rightward directions. The vehicle roof panel 7 is set to be larger in size than the actuation mechanism 5 to cover the entire actuation mechanism 5 from the upper side. The vehicle roof panel 7 includes a first opening 7a and a window 7b. The first opening 7a is formed in a front part of the vehicle roof panel 7 and configured to be in communication with the passenger compartment CR. The window 7b is arranged rearward from the first opening 7a. Further, the vehicle roof panel 7 includes a front end where a deflector is coupled so as to be pivotal upward and downward (not shown in FIG. 1).

As shown in FIGS. 1 to 4, the vehicle roof panel 7 is manufactured through two-color molding and includes a main panel body 71 and a surface layer 73. The main panel body 71 is formed from black-colored opaque plastic. As shown in FIGS. 2 to 4, the main panel body 71 is a plate including an outer surface 71a and an inner surface 71b (lower surface). The main panel body 71 includes an accommodation portion 711 shown in FIGS. 1 to 3, a second opening 712 shown in FIGS. 1 and 4, and a peripheral portion 713 shown in FIGS. 1 to 4.

As shown in FIGS. 1 to 3, the accommodation portion 711 extends along the periphery of the first opening 7a and surrounds the first opening 7a. The accommodation portion 711 is shaped to be rectangular and slightly larger than the roof window 3. Specifically, the accommodation portion 711 includes a bottom surface 711a, a first side wall 711b, a second side wall 711c, and a flange surface 711d. The accommodation portion 711 is recessed downward from the peripheral portion 713. Accordingly, the accommodation portion 711 is configured to accommodate the roof window 3. The accommodation portion 711 is configured to collect water such as rain water to prevent the water from entering the passenger compartment CR. The water collected in the accommodation portion 711 such as rain water is drained through a drain (not shown) from the vehicle roof panel 7 and out of the body 1.

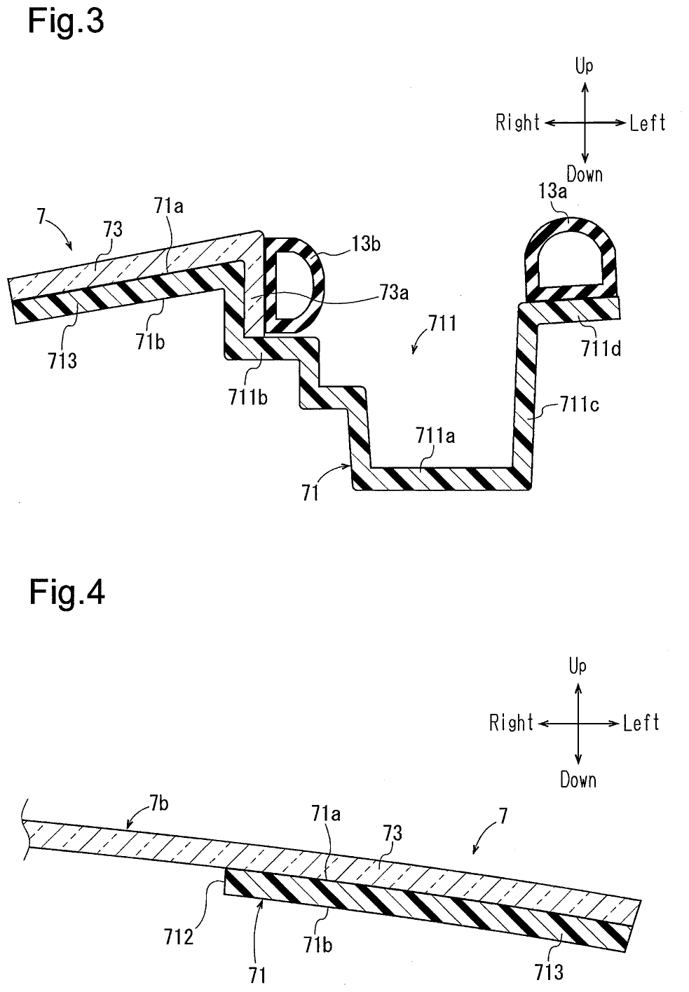

The bottom surface 711a is located at a lowermost part of the accommodation portion 711 and extends substantially horizontally. The bottom surface 711a is configured to collect water such as rain water as described above. Further, a deflector arm 11 is arranged on the bottom surface 711a to pivot the deflector upward and downward. The structure of the deflector arm 11 is the same as a known deflector arm and will not be described in detail. Further, to facilitate illustration the deflector arm 11 is schematically shown in FIG. 2. The deflector arm 11 is not shown in FIG. 3 and FIGS. 5 and 6, which will be described later.

The first side wall 711b extends upward in a stepped manner from the bottom surface 711a and integrates with the peripheral portion 713 at its upper end. The second side wall 711c opposes the first side wall 711b and extends substantially vertically upward from the bottom surface 711a. The flange surface 711d is connected to the upper end of the second side wall 711c and extends toward the first opening 7a. A first weather strip 13a is attached by an adhesive to the flange surface 711d.

As shown in FIGS. 1 and 4, the second opening 712 is located rearward from the accommodation portion 711 and shaped to be substantially rectangular. The vehicle roof panel 7 is fixed to the body panel 1a so that the second opening 712, as will be described later, is in communication with the passenger compartment CR. The peripheral portion 713 is continuous with the accommodation portion 711 and the second opening 712 and surrounds the accommodation portion 711 and the second opening 712. The peripheral portion 713 determines the outer shape of the main panel body 71 and the vehicle roof panel 7.

As shown in FIGS. 2 to 4, the surface layer 73 is formed from a transparent plastic. The surface layer 73 is formed on the outer surface 71a of the main panel body 71 and integrated with the outer surface 71a. Accordingly, the surface layer 73 covers the main panel body 71 and defines the surface of the vehicle roof panel 7. More specifically, the surface layer 73 extends to the accommodation portion 711 while entirely covering the second opening 712 and the peripheral portion 713 of the main panel body 71. As shown in FIGS. 2 and 3, the surface layer 73 includes an extension portion 73a that extends downward along the second side wall 711c. Accordingly, the surface layer 73 extends in the accommodation portion 711 and covers part of the second side wall 711c and part of the accommodation portion 711. A second weather strip 13b, which projects into the accommodation portion 711, is attached by an adhesive to the extension portion 73a. The first weather strip 13a and the second weather strip 13b may have any shape.

With the vehicle roof panel 7, as shown in FIG. 4, the window 7b is formed by the portion of the surface layer 73 covering the second opening 712. That is, the window 7b is formed from the transparent plastic.

With the roof structure, as shown by the arrowed dashed lines in FIG. 1, the open-close devices 5b are arranged in the first opening 7a and the actuation mechanism 5 is fixed to the vehicle roof panel 7 from the side of the inner surface 71b of the main panel body 71. Accordingly, with the vehicle roof panel 7, the main panel body 71 is in a state covering the actuation mechanism 5 from the upper side. In such a state, as shown by the arrowed broken lines in FIG. 1, the vehicle roof panel 7 is accommodated in the opening 10. As shown in FIG. 2, with the vehicle roof panel 7, the inner surface 71b of the main panel body 71 is fixed to the body panel 1a with a urethane layer 17 located in between. The urethane layer 17 bonds the main panel body 71 and the body panel 1a and prevents water such as rain water from entering the passenger compartment CR through the boundary between the main panel body 71 and the body panel 1a.

As shown by the arrowed double-dashed lines in FIG. 1, the roof window 3 is accommodated in the accommodation portion 711 of the vehicle roof panel 7. Further, the open-close devices 5b of the actuation mechanism 5 are coupled on the second surface 3b of the roof window 3 shown in FIG. 2. When the roof window 3 is accommodated in the accommodation portion 711, the first weather strip 13a contacts the second surface 3b and elastically deforms while the second weather strip 13b contacts the periphery of the roof window 3 and elastically deforms. As a result, the first and second weather strips 13a and 13b seal the boundary of the roof window 3 and the accommodation portion 711. Additionally, in the roof structure, when the roof window 3 is accommodated in the accommodation portion 711, the surface layer 73 is substantially flush with the first surface 3a of the roof window 3 in the vehicle roof panel 7. “Substantially flush” includes a case in which a step of an extent is formed in the upward and downward directions between the surface layer 73 and the first surface 3a of the roof window 3 in addition to a case in which the surface layer 73 is completely flush with the first surface 3a of the roof window 3.

In this manner, in the roof structure, the actuation mechanism 5 is arranged at a location opposing the second surface 3b of the roof window 3, and the vehicle roof panel 7 is located between the roof window 3 and the actuation mechanism 5. This completes the roof structure.

With the above roof structure, the roof window 3 and the window 7b of the vehicle roof panel 7 allow light to enter the passenger compartment CR from the vehicle roof. Further, the open-close devices 5b of the actuation mechanism 5 move the roof window 3 relative to the vehicle roof panel 7 in the frontward and rearward directions of the vehicle so that the first opening 7a, the accommodation portion 711, and consequently the passenger compartment CR can be opened and closed.

With the roof structure, the vehicle roof panel 7 is formed from a plastic. Thus, compared to when the vehicle roof panel 7 is formed from a metal, the weight of the roof structure and the vehicle is reduced. Further, the plastic vehicle roof panel 7 simplifies the manufacturing process.

The vehicle roof panel 7 includes the main panel body 71, which is formed from a black opaque plastic, and the surface layer 73, which is formed from a transparent plastic. Accordingly, as described above, when the vehicle roof panel 7 covers the actuation mechanism 5, the main panel body 71 conceals the actuation mechanism 5. In the roof structure, the roof window 3 includes the concealing portion 9. Thus, the concealing portion 9 can also conceal portions where the roof window 3 and the open-close devices 5b are coupled.

Moreover, with the vehicle roof panel 7, the surface layer 73 is formed integrally with the outer surface 71a of the main panel body 71. Accordingly, when viewing the vehicle roof panel 7 from the outer side of the vehicle, the black main panel body 71 is visible through the transparent surface layer 73. In this way, with the roof structure, the surface layer 73 has an appearance providing a sense of depth to the vehicle roof panel 7, and the appearance is close to that of the transparent roof window 3. When the roof window 3 is accommodated in the accommodation portion 711, the surface layer 73 is substantially flush with the first surface 3a. Accordingly, with the roof structure, the vehicle roof panel 7 has an aesthetic appeal and provides a uniform appearance with the roof window 3.

With the roof structure, the vehicle roof panel 7 includes the surface layer 73 formed from a transparent plastic. This eliminates the need for elaborative coloring of the main panel body 71 to obtain an appearance close to that of the roof window 3. In this respect, the roof structure also simplifies the manufacturing process.

Thus, the roof structure according to the first embodiment has high aesthetic appeal and reduces the manufacturing cost.

Particularly, with the roof structure, the surface layer 73 includes the extension portion 73a in the vehicle roof panel 7 so that the surface layer 73 extends in the accommodation portion 711 and covers part of the first side wall 711b. Accordingly, with the vehicle roof panel 7, the boundary between the accommodation portion 711 and the main panel body 71 is not visible. In this respect, the roof structure has high aesthetic appeal. Further, with the roof structure, the boundary between the main panel body 71 and the surface layer 73 is not exposed in the accommodation portion 711. This prevents water such as rain water from entering the boundary and separating the main panel body 71 from the surface layer 73. Further, with the roof structure, when forming the surface layer 73, the design of a mold can be simplified. This further simplifies the manufacturing process.

### Second Embodiment

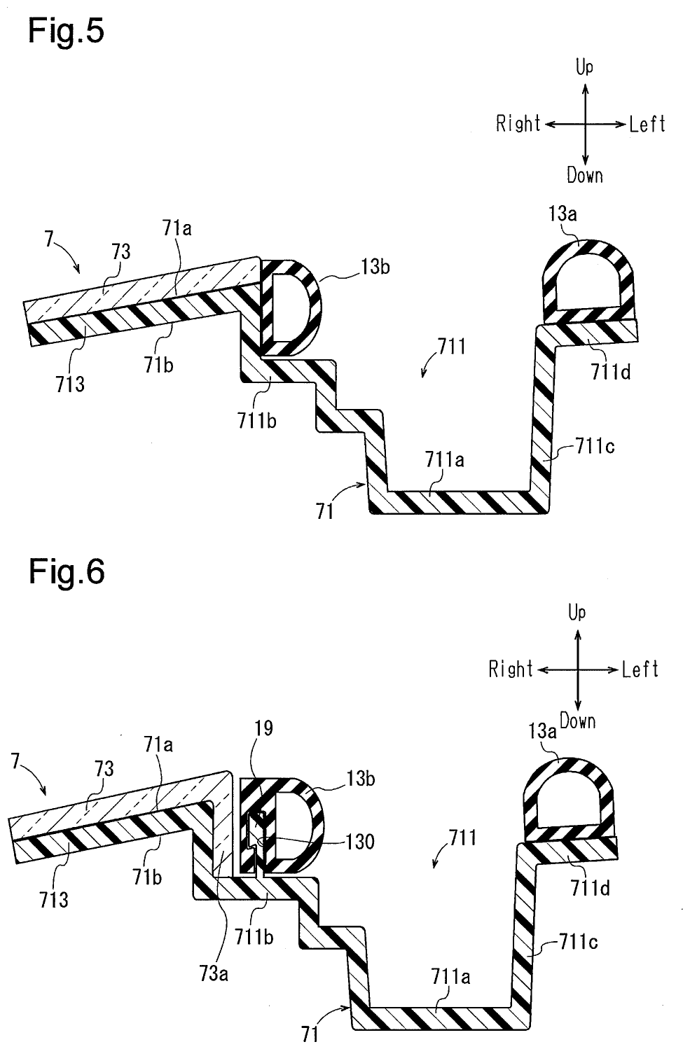

In a roof structure according to the second embodiment, as shown in FIG. 5, the extension portion 73a of the surface layer 73 is omitted from the vehicle roof panel 7. With this vehicle roof panel 7, the surface layer 73 does not extend in the accommodation portion 711 and only covers the second opening 712 and the peripheral portion 713. Otherwise, the roof structure of the second embodiment, including the vehicle roof panel 7, is the same as the first embodiment. Same reference numerals are given to those components that are the same as the first embodiment. Such components will not be described in detail.

With this roof structure, there is no need to arrange the extension portion 73a to the surface layer 73 of the vehicle roof panel 7. This reduces the amount of the transparent plastic required for forming the surface layer 73. Accordingly, the roof structure further reduces the manufacturing cost. Other advantages of the roof structure are the same as the roof structure according to the first embodiment.

### Third Embodiment

In a roof structure according to the third embodiment, as shown in FIG. 6, the accommodation portion 711 includes an engaging projection 19 on the main panel body 71 of the vehicle roof panel 7. More specifically, the engaging projection 19 is formed integrally with the first side wall 711b and extends upward. Further, the second weather strip 13b includes an engagement portion 130 that is engaged with the engaging projection 19. The engaging projection 19 and the engagement portion 130 can be designed to have any shape. Other advantages of the roof structure are the same as the roof structure according to the first embodiment.

With this roof structure, the engaging projection 19 and the engagement portion 130 are engaged so that the second weather strip 13b is fixed to the vehicle roof panel 7. Accordingly, with this roof structure, compared to when attaching the second weather strip 13b to the vehicle roof panel 7, the second weather strip 13b is coupled more easily to the vehicle roof panel 7. Other advantages of the roof structure are the same as the roof structure according to the first embodiment.

### Fourth Embodiment

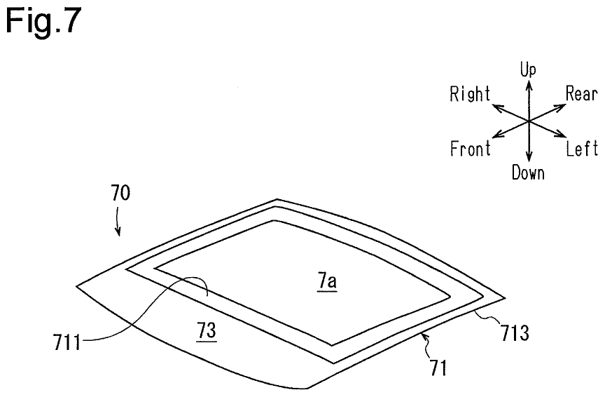

A roof structure according to the third embodiment includes a vehicle roof panel 70 shown in FIG. 7 instead of the above vehicle roof panel 7. In the same manner as the vehicle roof panel 7, the vehicle roof panel 70 is formed by a main panel body 71 and the surface layer 73. With the vehicle roof panel 70, the main panel body 71 does not include the second opening 712. Accordingly, the vehicle roof panel 70 does not include the window 7b. Further, the vehicle roof panel 70 has a smaller length in the frontward and rearward directions than the vehicle roof panel 7 and thereby reduced in size. The roof structure includes the actuation mechanism 5 that is also reduced in size (not shown) in accordance with the vehicle roof panel 70. Other advantages of the roof structure are the same as the roof structure according to the first embodiment.

With the roof structure, the vehicle roof panel 70 is reduced in size thereby reducing the manufacturing cost in comparison with the roof structure according to the first embodiment. Further, when the vehicle roof panel 70 is reduced in size, the roof structure is also reduced in size. This enables the roof structure to be employed to a wider variety of vehicle types. Other advantages of the roof structure are the same as the roof structure according to the first embodiment.

It should be apparent to those skilled in the art that the present invention may be embodied in many other specific forms without departing from the spirit or scope of the invention. Therefore, the present examples and embodiments are to be considered as illustrative and not restrictive, and the invention is not to be limited to the details given herein, but may be modified within the scope and equivalence of the appended claims.

For example, the elements in the first to fourth embodiments may be combined when constructing the roof structure.

In addition, the roof window 3 in the roof structure according to the first embodiment is formed from an inorganic glass. Instead, the roof window 3 may be formed from a transparent plastic. The roof windows 3 in the second to fourth embodiments may also be formed in the same manner.

The window 7b may be omitted from the vehicle roof panel 7 while maintaining the length in the frontward and rearward directions. Further, the vehicle roof panel 7 may include a plurality of the windows 7b.

With the roof structure according to the first embodiment, the actuation mechanism 5 is fixed to the vehicle roof panel 7 on the inner surface 71b of the main panel body 71. Instead, the actuation mechanism 5 may be fixed to the body panel 1a on the side of the passenger compartment CR. The actuation mechanisms 5 in the second to fourth embodiments may also be arranged in the same manner.

1. A vehicle roof panel that is formed from a plastic, configured to be arranged between a roof window that is a transparent plate and an actuation mechanism that actuates the roof window, and configured to be fixed to a vehicle body, wherein:
the roof window includes a first surface and a second surface located on an opposite side of the first surface;
the actuation mechanism is arranged to oppose the second surface of the roof window; and
the vehicle roof panel includes
a main panel body that is formed from an opaque plastic, includes an accommodation portion configured to accommodate the roof window, and is configured to conceal the actuation mechanism, and
a surface layer that is formed from a transparent plastic, integrated with an outer surface of the main panel body, and substantially flush with the first surface.

2. The vehicle roof panel according to claim 1, wherein the surface layer extends in the accommodation portion.

3. A roof structure, comprising:
a roof window that is a transparent plate and includes a first surface and a second surface located on an opposite side of the first surface;
an actuation mechanism arranged to oppose the second surface of the roof window and configured to actuate the roof window; and
a vehicle roof panel that is formed from a plastic, arranged between the roof window and the actuation mechanism, and configured to be fixed to a vehicle body,
wherein the vehicle roof panel includes
a main panel body that is formed from an opaque plastic, includes an accommodation portion configured to accommodate the roof window, and is configured to conceal the actuation mechanism and
a surface layer that is formed from a transparent plastic, integrated with an outer surface of the main panel body, and is substantially flush with the first surface.
